(19) United States
(12) Patent Application Publication
(10) Pub. No.: US 2026/0369055 A1
(43) Pub. Date: Nov. 19, 2026

(54) TECHNIQUES FOR GENERATING VISUAL ACTION LOOPS FOR ACCOMPLISHING OBJECTIVES OF WEARERS OF AUGMENTED REALITY DEVICES

(71) Applicant: Meta Platforms Technologies, LLC, Menlo Park, CA (US)

(72) Inventors: Andrew Garrod Bosworth, San Mateo, CA (US); Alexander James Himel, Woodside, CA (US)

(21) Appl. No.: 19/676,702

(22) Filed: May 13, 2026

Related U.S. Application Data
(60) Provisional application No. 63/805,176, filed on May 13, 2025.

(51) Int. Cl. G06V 20/20; G06F 3/01; G06F 40/40; G06T 11/00; G06V 20/68

(52) U.S. Cl. CPC G06V 20/20; G06F 3/011; G06F 40/40; G06T 11/00; G06V 20/68

(57) ABSTRACT

A method performed at an augmented-reality (AR) device in electronic communication with an AI system multiple large language models (LLMs) is described. A first LLM presents user interface elements for identifying performance objectives of a wearer. After identifying the performance objectives, a second LLM causes one or more imaging sensors of the AR device to obtain images of physical surroundings of the wearer directed to a physical object recognized as usable for performing an activity for accomplishing an objective, and causes presentation of a prompt requesting additional information about the recognized physical object. Additional data captured in response to the prompt is provided to a third LLM. In accordance with a determination by the third LLM that visualization criteria are met, the AR device presents visual representations of activities for accomplishing the objective, including at least one visual representation depicting the recognized physical object being used to perform the activity.

### RELATED APPLICATIONS

This application claims priority to U.S. Provisional Patent Application Serial No. 63/805,176, filed May 13, 2025, entitled “Techniques for Generating Visual Action Loops for Accomplishing Objectives of Wearers of AR Devices,” which is incorporated herein by reference by reference.

### TECHNICAL FIELD

This relates generally to wearable electronic devices for facilitating interactions with artificially-intelligent (AI) assistive systems, including but not limited to AI assistive systems that use personalized user data to provide visual action plans for accomplishing a users’ objectives.

### SUMMARY

Existing systems are capable of capturing sensor data, which is generally utilized to perform visualization (e.g., simulating elements of the users’ physical environment from the AR system). Current objective tracking technologies like workout and diet goals are often presented in a format (e.g., a list format, a tabular format, and/or a dashboard interface) which are generally dissimilar with a user’s perception of reality.

AI systems are capable of utilizing user data to personalize outputs for the user providing a prompt to the AI systems. AI systems are often not tailored to provide responses using detailed particularized sensor data (e.g., from a wearable device), and instead tend to be relatively general.

This application describes systems where personalized user inputs are provided to an AI model (e.g., information indicating a particular fitness goal that a user wants to accomplish, behavioral data or localized imaging data personal to the user), and the AI model can generate one or more visual representations of actions and activities that the user will need to perform to achieve the particular goal. Stated another way, the AI at the OS level can act as an orchestrator to launch certain applications at points in time and provide context to the applications in furtherance of the users’ goals. For example, if a user inputs a goal of losing five pounds in a month, the AI system can be configured to create a visual roadmap of exercises and dietary constraints that the user could follow in order to achieve the goal.

In accordance with some embodiments, the AI orchestrator operating at the OS level may launch one or more specific applications at particular points in time and provide context to each launched application in furtherance of the wearer’s performance objectives. For example, the AI orchestrator may launch a workout or fitness application when the AI system determines, based on time of day, calendar data, and/or detection of exercise equipment in the wearer’s physical surroundings, that the wearer is due for a scheduled workout. In another example, the AI orchestrator may launch a meal-planning or recipe application around mealtimes, or when the wearer is detected in a kitchen or at a dining table, to present a weekly meal plan or recipe guidance aligned with the wearer’s nutrition goals.

In another example, the AI orchestrator may launch a shopping or grocery application when the wearer is recognized as being in a grocery store or other retail environment (e.g., based on audio context such as point-of-sale sounds or shopping cart sounds, or based on image context indicating grocery aisles or products) to surface a shopping list generated from the meal plan. In some embodiments, the AI orchestrator may launch a calendar or scheduling application to automatically schedule workouts, shopping trips, and meal-prep sessions, and to provide personalized status updates relating to progress toward a performance objective. In another example, the AI orchestrator may launch a hydration-tracking application at regular intervals (e.g., every 15 minutes) when a water container is recognized in the wearer’s surroundings. In some embodiments, the AI orchestrator may launch a networking or contacts application when the AI system detects, via one or more audio sensors, a nearby conversation on a topic relevant to the wearer’s expertise or relationship-building goals, to surface suggested talking points or contact exchange flows. In another example, the AI orchestrator may launch a navigation or mapping application when the wearer’s location data and time-based data indicate that the wearer should travel to a gym, store, or other location associated with an intermediate task. In some embodiments, the AI orchestrator may provide context to each launched application, such as the relevant performance objective, recognized physical objects in the wearer’s surroundings, user context data, and/or prior progress toward the performance objective, such that the launched application can present content tailored to the wearer’s current goal.

In accordance with some embodiments, the AI system can proactively trigger visual action loops based on contextual factors without requiring explicit user initiation. Proactive triggers can include what the user is seeing (visual), what the user is hearing (audio), where the user is (location), and time-based factors. For example, the system can detect that the user has been sedentary for an extended period and, upon recognizing exercise equipment in the user’s surroundings, prompt the user to perform a physical activity.

In accordance with some embodiments, the AI system can detect audio context from the user’s physical surroundings to trigger visual action loops. Audio signals can provide rich contextual information, including sounds associated with particular environments (e.g., sounds of a hardware store, gym, or kitchen), ambient sounds that indicate a location type (e.g., traffic sounds, nature sounds, water sounds), and conversational context. In some embodiments, audio context can localize the user better than GPS signals—for example, standing outside with eyes closed, a user can usually determine where they are based on sounds such as how loud the traffic is, whether people are walking by, and whether there is nature or water nearby.

In accordance with some embodiments, the AI system can provide health-conscious food suggestions based on the user’s performance objectives. For example, if the user’s goal is to lose weight, the system can recognize food items in the user’s surroundings (e.g., grilled chicken next to fried chicken) and encourage the user to select the healthier choice. The system can also suggest healthier alternatives, such as cauliflower rice instead of regular rice, or an alternative dish instead of frozen chicken nuggets.

In accordance with some embodiments, the AI system can provide hydration reminders to the user. The system can track the user’s water consumption throughout the day and, upon recognizing a water container in front of the user, prompt the user to drink at regular intervals (e.g., every 15 minutes) to meet hydration goals.

In accordance with some embodiments, the AI system can generate a multi-day meal plan (e.g., a weekly meal plan) based on the wearer’s performance objectives. The meal plan can include recommended breakfast, lunch, and dinner menus, recipes, and snack suggestions for each day of a planning period (e.g., a week). In some embodiments, the meal plan can be generated based on the wearer’s nutrition goals (e.g., a target calorie or macronutrient intake), workout history (e.g., daily calories burned, completed workout sessions), dietary preferences or restrictions, and/or geographical location of the wearer. In some embodiments, the AI system can cause presentation of a visual action loop depicting the meal plan over the planning period, including selectable representations of individual meals that, when selected, cause presentation of recipe guidance, ingredient lists, and preparation steps.

In some embodiments, the AI system can generate a shopping list based on the ingredients required for the meal plan, and can cause presentation of the shopping list (e.g., via a grocery or shopping application launched by the AI orchestrator when the wearer is recognized as being in a retail environment). In some embodiments, the AI system can provide personalized status updates relating to progress through the meal plan, such as reminders to consume a recovery shake after a workout session or notifications surfacing a recommended lunch or dinner aligned with the wearer’s fitness goals. In some embodiments, the meal plan can be updated dynamically based on the wearer’s adherence to prior meals, sensor data from a third-party sensor device (e.g., a glucose monitor or heart rate monitor), and/or detected changes to the wearer’s performance objectives.

In accordance with some embodiments, the AI system can provide time-based triggers for visual action loops. The system can track time and activity history throughout the day and determine that the user has been sitting for an extended period (e.g., four hours) and is overdue for exercise, particularly when exercise equipment such as a pull-up bar is detected in front of the user.

In accordance with some embodiments, the AI system can cause presentation, via the AR device, of personalized status updates relating to the wearer’s progress toward one or more performance objectives. The personalized status updates can be generated based on loop particularization data (e.g., the performance objectives, user context data, and/or image context data) and/or sensor data received from a wrist-wearable device or third-party sensor device. In some embodiments, the personalized status updates can include one or more of an indication of progress toward a respective performance objective, a comparison between current progress and a target rate of progress, a reminder of a next intermediate task to be performed, a recommendation to adjust an activity based on detected adherence, and/or a summary of completed intermediate tasks over a defined time period.

In accordance with some embodiments, the AI system can automatically schedule activities on a calendar associated with the wearer in furtherance of one or more performance objectives. For example, the AI system can cause a calendar or scheduling application to automatically place workout sessions, grocery shopping trips, meal-prep sessions, hydration reminders, and/or other intermediate tasks at respective times on the wearer’s calendar based on the wearer’s performance objectives, availability information (e.g., open time slots, preferred workout times, days per week the wearer wants to work out), the user context data (e.g., workout history, dietary preferences, equipment access, location data), and/or the image context data (e.g., recognized exercise equipment, recognized food items, recognized retail environments). In some embodiments, the automatically scheduled activities can be added as calendar entries that trigger presentation of corresponding visual action loops at the AR device at the scheduled times. In some embodiments, the schedule of activities can be adapted over time based on the wearer’s adherence to previously scheduled activities, sensor data received from a wearable device or third-party sensor device, and/or detected changes to the performance objectives, such that subsequent activities are rescheduled or substituted to help the wearer realize the performance objectives.

In accordance with some embodiments, the AI system can integrate data from third-party sensor devices worn by the user, such as glucose monitors and heart rate monitors (which may be implemented as a watch). The sensor data from these third-party devices can be used to inform the generation of visual action loops and provide more personalized recommendations to the user.

In accordance with some embodiments, the AI system can detect social and networking contexts to provide visual action loops for relationship-building objectives. For example, the system can detect conversation topics in the user’s surroundings via audio sensors and determine that a topic is relevant to the user’s expertise or interests, prompting the user with suggested talking points or networking actions.

In accordance with some embodiments, the AI system can be implemented using a plurality of large language models (LLMs), in which different LLMs are configured to perform different respective functions within the AI system. For example, the AI system can include (i) a first LLM configured to identify objectives for the wearer to accomplish (e.g., by presenting and processing user inputs directed to one or more user interface elements related to identifying objectives), (ii) a second LLM configured to cause the AR device to obtain relevant data about the physical surroundings of the wearer (e.g., by causing one or more imaging sensors of the AR device to capture image data of physical objects in the surroundings, and by causing presentation of prompts requesting additional information about a recognized physical object), and (iii) a third LLM configured to cause the AR device to present visual representations of activities for the wearer to perform (e.g., by determining whether visualization criteria are met based on data gathered about the physical surroundings, and causing presentation of a set of visual representations of respective activities). In some embodiments, the first LLM, the second LLM, and the third LLM correspond to, or are implemented in conjunction with, the task identification module, the particularization module, and the visual orchestration module of a model library of the AI system, respectively. In some embodiments, two or more of the first LLM, the second LLM, and the third LLM are implemented as a single LLM configured to perform two or more of the foregoing functions, or as distinct instances of a common LLM operating with different prompts and contexts. The plurality of LLMs can be implemented locally at the AR device, at one or more communicatively coupled devices (e.g., a wrist-wearable device, an intermediary processing device, or a server), or distributed across a combination thereof.

In accordance with some embodiments, the third LLM is configured to determine whether visualization criteria are met based on additional data captured about a physical object in the physical surroundings of the wearer before causing presentation of the set of visual representations. The visualization criteria can include any one or more of: (i) a sufficiency criterion that is satisfied when a threshold amount of data about the physical object has been gathered (e.g., a threshold number of images captured from different angles, or image data of a threshold portion of the physical object); (ii) a recognition-confidence criterion that is satisfied when a confidence score associated with the AI system’s recognition of the physical object meets or exceeds a confidence threshold; (iii) an object-suitability criterion that is satisfied when the physical object belongs to a class of objects associated with the identified performance objective (e.g., the physical object is an item of exercise equipment when the identified performance objective is a fitness goal); (iv) a positional criterion that is satisfied when the physical object is positioned within the wearer’s field of view in a manner that allows for the visual representation to be overlaid on or proximate to the physical object; and/or (v) an availability criterion that is satisfied when the third LLM has access to a visual representation suitable for depicting the respective activity being performed using the physical object (e.g., from a library of pre-generated visual representations, or via a generative process). In accordance with a determination that one or more of the visualization criteria are not met, the AI system can be configured to cause the second LLM to request further information from the wearer or to cause additional image data to be captured before generating the set of visual representations.

Instructions that cause performance of the methods and operations described herein can be stored on a non-transitory computer readable storage medium. The non-transitory computer-readable storage medium can be included on a single electronic device or spread across multiple electronic devices of a system (e.g., a computing system comprising one or more distributed servers). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on an AR device or can be stored on a combination of an AR device and an associated input device (e.g., a wrist-wearable device) such that instructions for causing detection of input operations can be performed at the input device and instructions for causing changes to a displayed user interface in response to those input operations can be performed at the AR device. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A to 1J illustrate a sequence of interactions with an AI system that is configured to provide visual action loops for accomplishing user goals, in accordance with some embodiments.

FIG. 2 shows an example method flow chart for generating a visual action plan for a set of actions that a user is seeking to accomplish, in accordance with some embodiments.

FIGS. 3A, 3B, 3C-1 and 3C-2, illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user’s physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user’s hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user’s hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user’s hand or another finger, on the user’s leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user’s possession (e.g., smartphones, laptops, imaging devices, intermediary devices, and/or other devices described herein).

The input modalities as alluded to above can be varied and are dependent on a user’s experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user’s heart rate; (v) peripheral oxygen saturation (SpO₂) sensors for measuring blood oxygen saturation and/or other biometric data of a user; (vi) capacitive sensors for detecting changes in potential at a portion of a user’s body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user’s environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

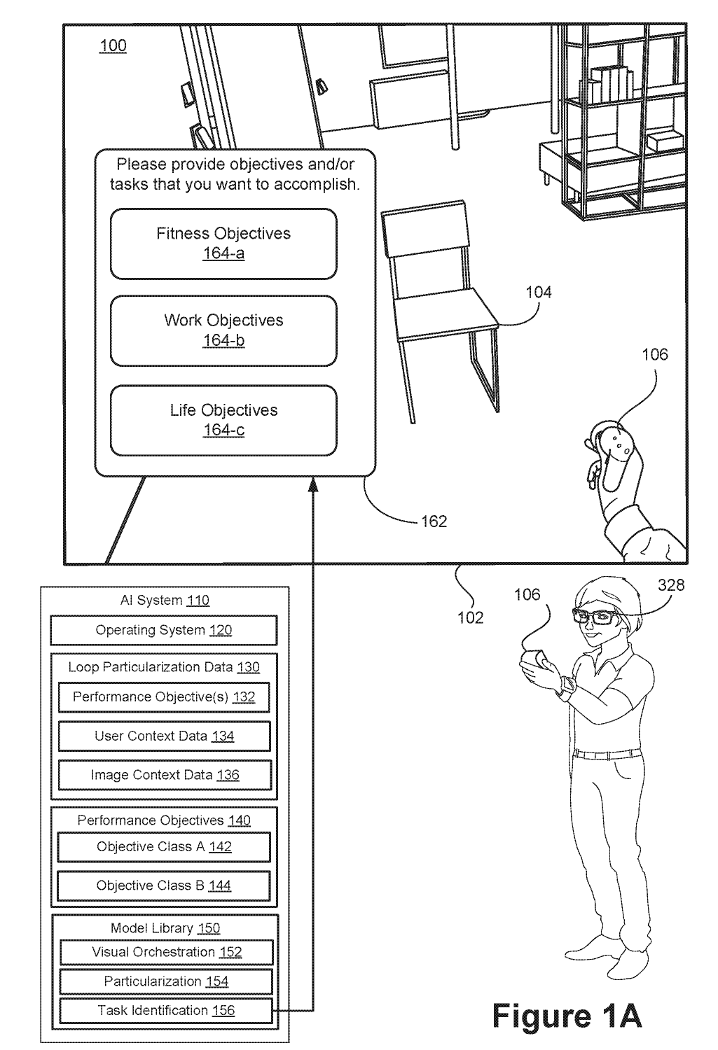

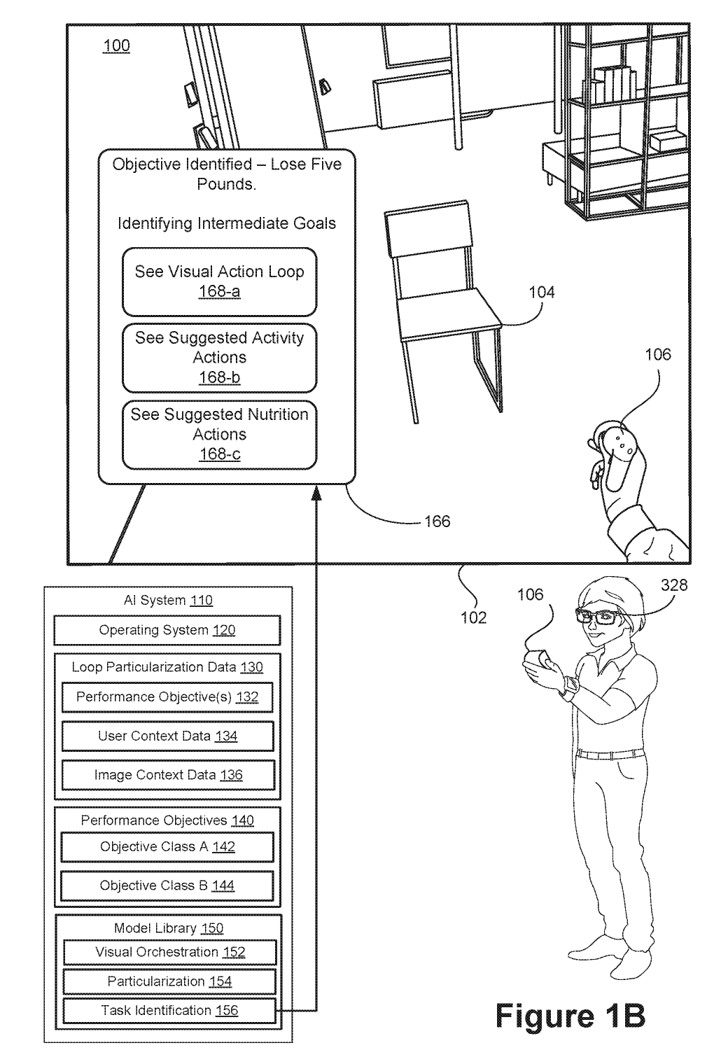

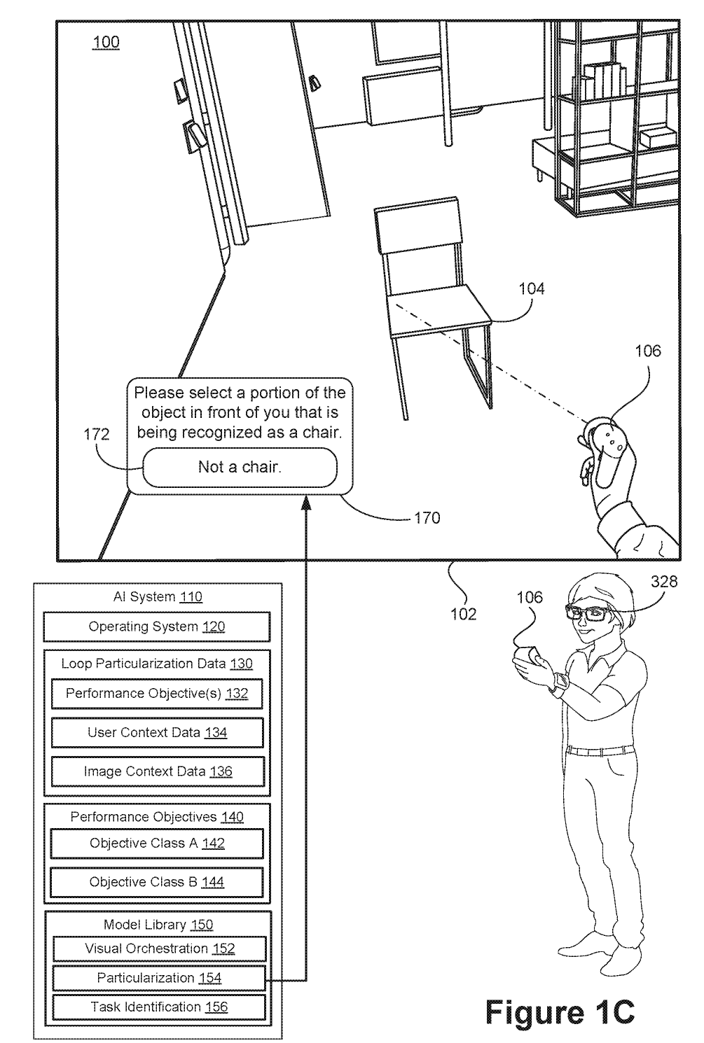

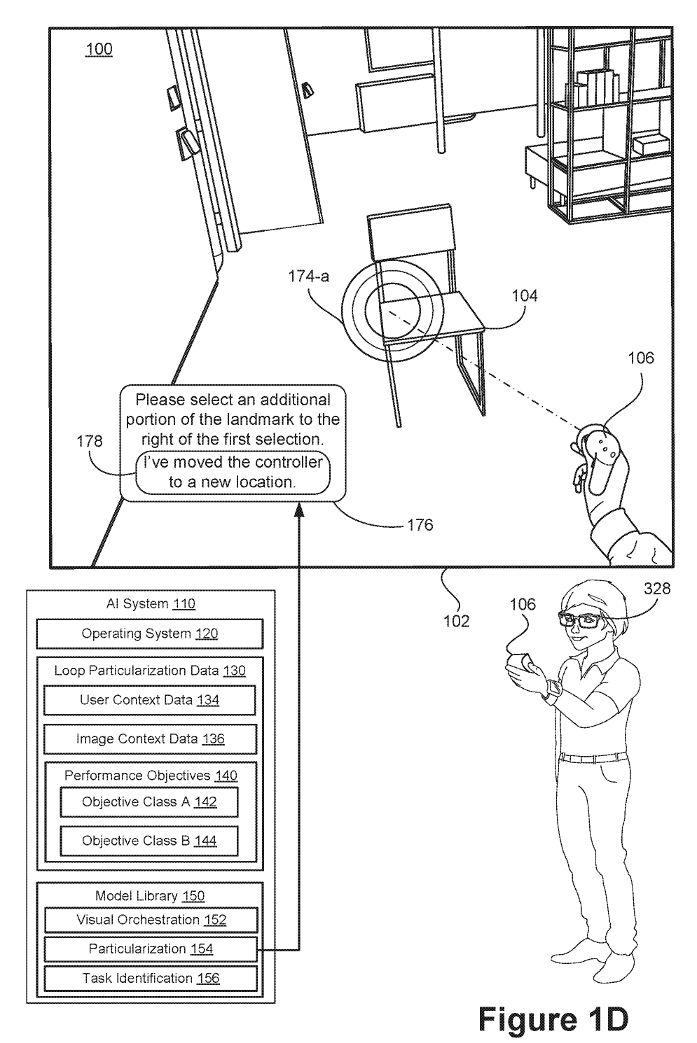

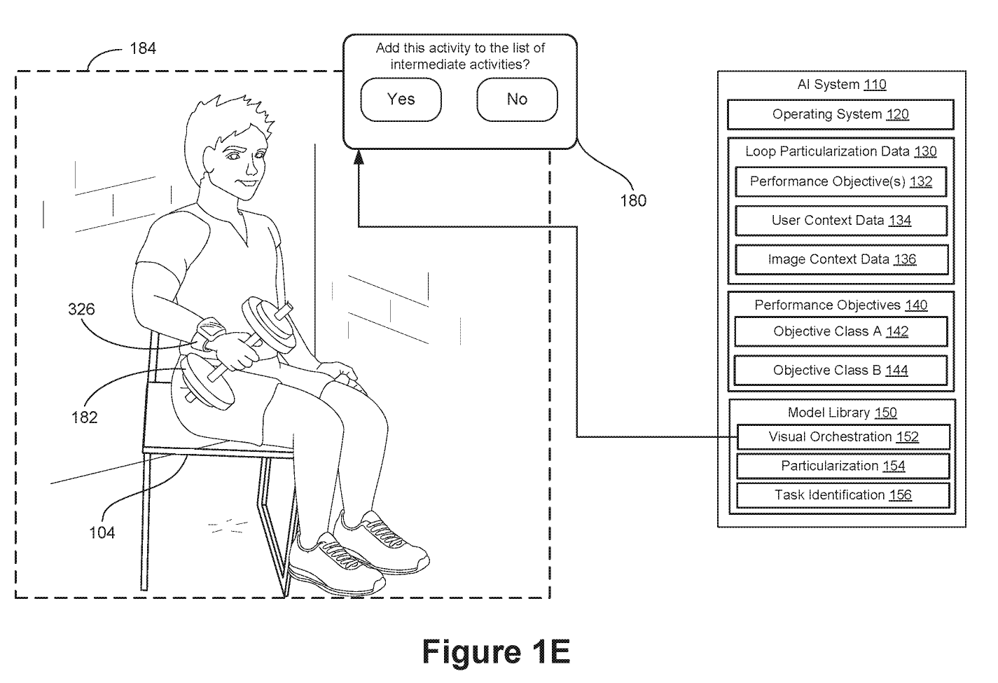

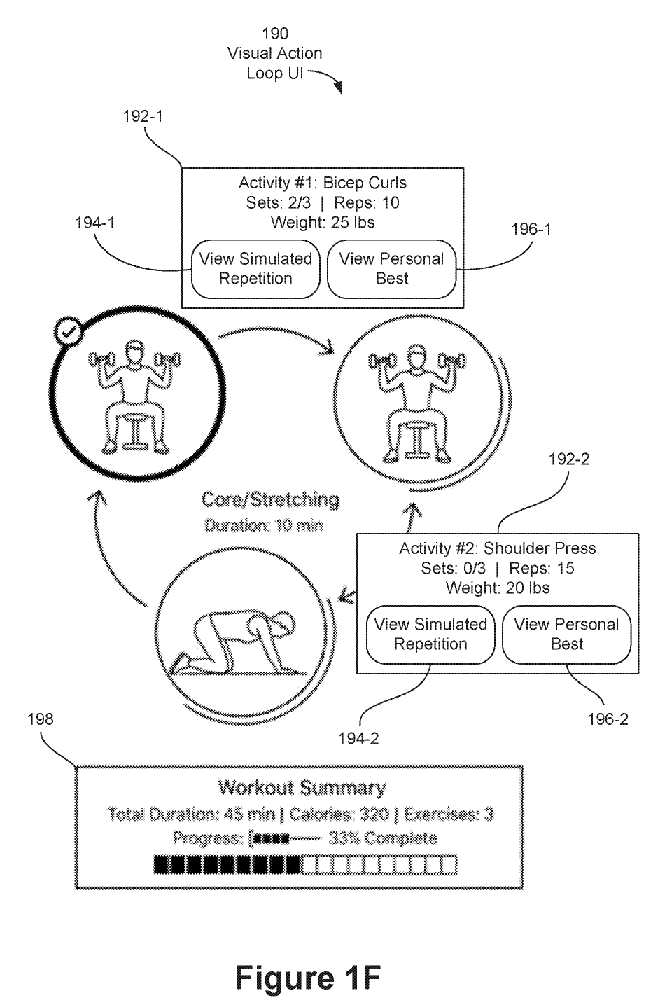

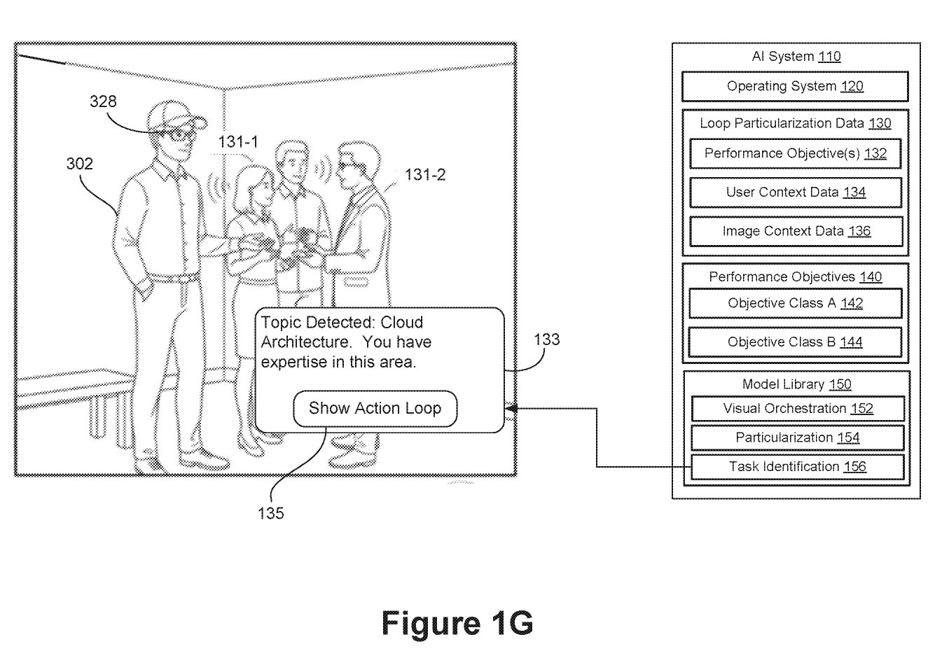

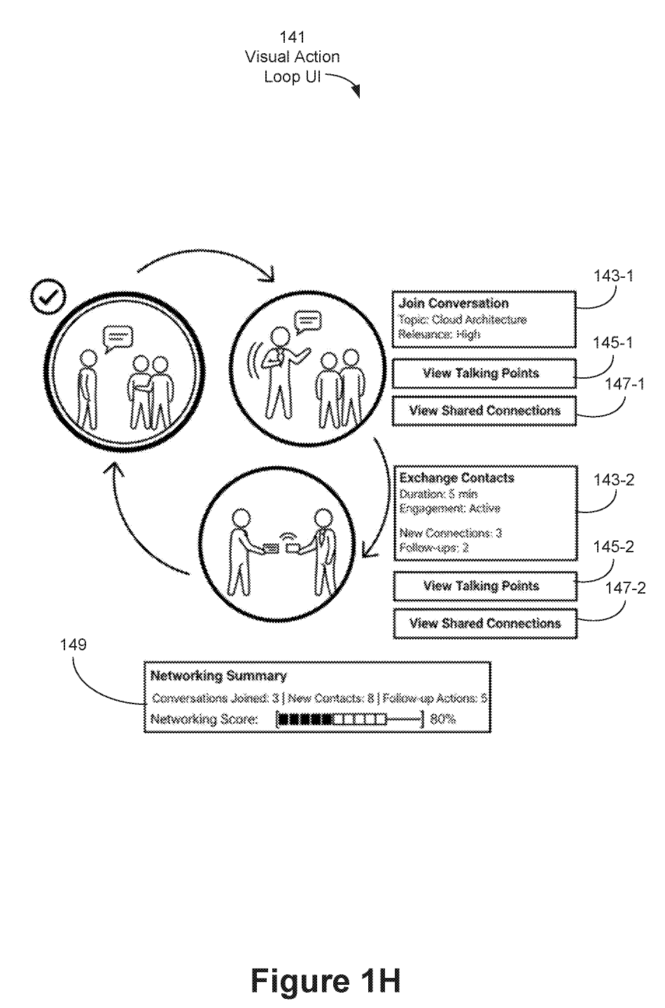

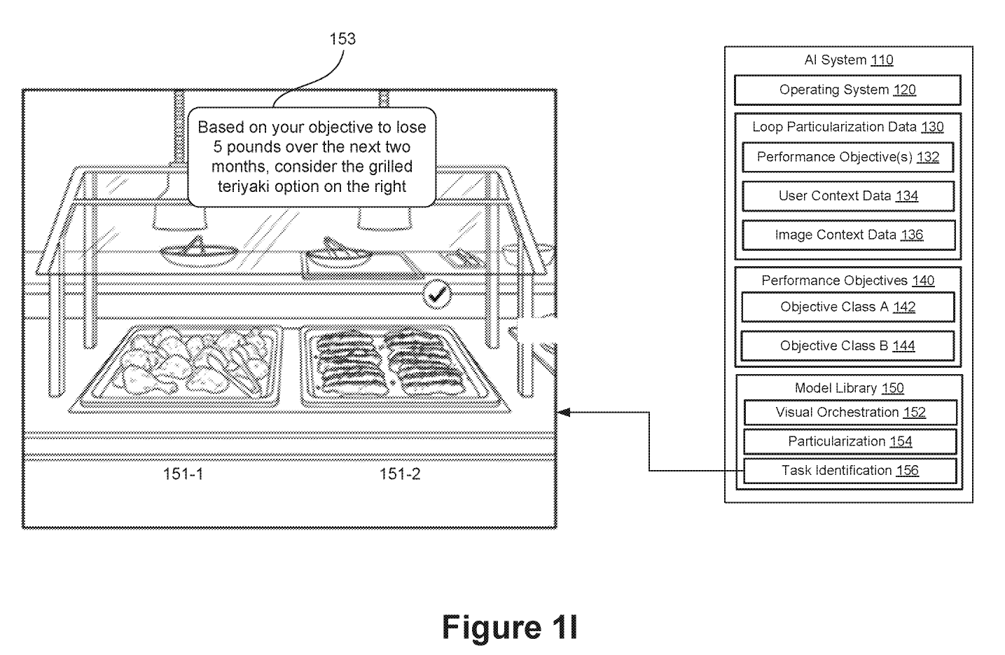

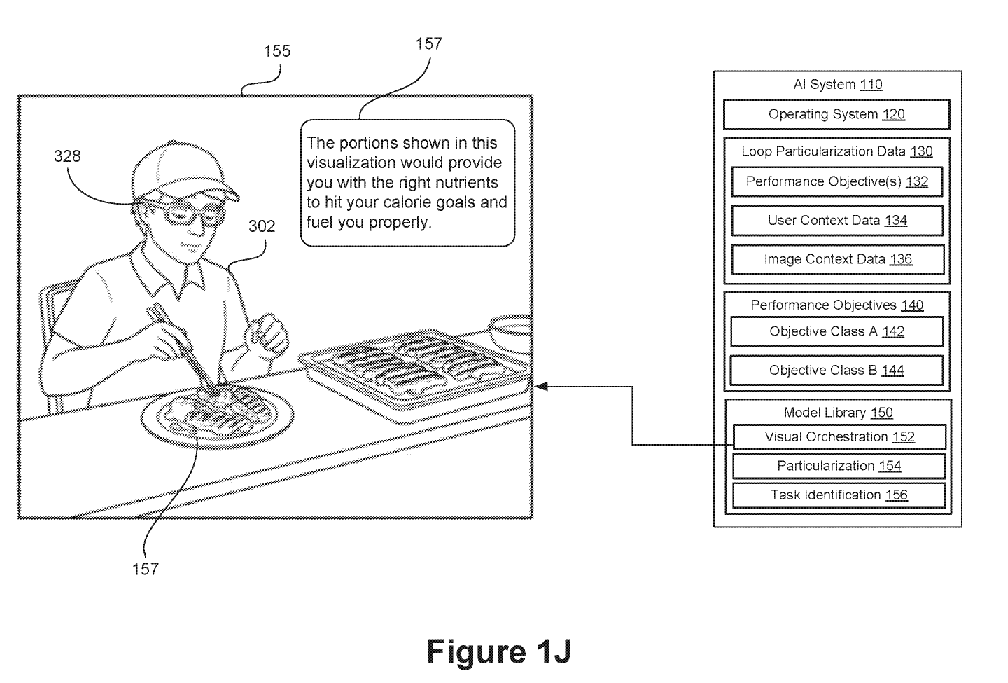

FIGS. 1A to 1J illustrate a sequence of interactions with an AI system 110 that is configured to provide visual action loops for accomplishing user goals, in accordance with some embodiments. For ease of description, portions of the sequence described herein may only be described in text (e.g., where a particular alternative embodiment would be acceptable for causing performance of a distinct element depicted in the figures described herein.

FIG. 1A shows a user in a room capturing imaging data of a field of view 102 about their physical surroundings via an AR device (e.g., data about a chair 104 in the user's surroundings). That is, in some embodiments, the systems described herein are configured to cause obtaining of image data about areas within a user’s surroundings (e.g., a physical scene, such as a portion of the user’s room, kitchen, home gym, etc.). In some embodiments, the wearer of the AR device 328 holds a hand-held controller 106 that can be used to interact with the AI system 110 and to select physical landmarks (e.g., the chair 104 or portions thereof) within the field of view 102, for example to cause one or more imaging sensors of the AR device 328 to gather additional data about a selected landmark.

FIG. 1A includes a block diagram depicting an AI system 110 being implemented (e.g., by the AR device 328), in accordance with some embodiments. In some embodiments, the AI system 110 includes an operating system 120, the operating system 120 configured to be co-operational with the AI system 110. In other words, the AI system 110 can be configured to operate at the OS level, in accordance with some embodiments.

In some embodiments, the AI system 110 includes a set of loop particularization data 130, which can be used by the AI system 110 to cause generation of visual action loops that are personalized for the AR device 328. For example, the loop particularization data 130 can include various information specific to the AR device 328 and/or a user of the AR device 328. The loop particularization data can include data gathered from the AR device 328, such as user context data 134 and image context data 136, in accordance with some embodiments. For example, the loop particularization data can include one or more performance objectives 132 identified at the AR device 328 (e.g., a fitness object to lose five pounds).

In some embodiments, the AI system 110 includes a model library 150 comprising a plurality of modules usable to generate visual action loops, including a visual orchestration module 152, a particularization module 154, and a task identification module 156. In some embodiments, the visual orchestration module 152 is configured to coordinate the presentation of visual representations within the field of view 102 via the AR device 328. In some embodiments, the particularization module 154 is configured to personalize the visual action loops based on the loop particularization data 130, including by causing gathering of additional data relevant to particular physical objects or landmarks within the wearer’s physical surroundings (e.g., by causing presentation of user interfaces prompting the wearer for additional information). In some embodiments, the task identification module 156 is configured to identify one or more intermediate tasks or activities for accomplishing the performance objectives 140 of the wearer. In some embodiments, the AI system 110 further includes a set of performance objectives 140, which can include one or more objective classes (e.g., objective class A 142 and objective class B 144) corresponding to respective categories of objectives (e.g., fitness objectives, work objectives, life objectives) that the wearer may seek to accomplish.

An AI model is providing a prompt at a user interface 162, which is being presented by the AR device 328. The user interface 162 includes a prompt (e.g., “Please provide objectives and/or tasks that you want to accomplish.”). In some embodiments, the user interface 162 is a first user interface presented at an initial stage of an interaction sequence with the AI system 110 to elicit one or more performance objectives from the wearer, and subsequent user interfaces (e.g., user interface 166 of FIG. 1B and user interface 170 of FIG. 1C) may be presented at later stages of the same interaction sequence as the AI system 110 progresses from objective identification to physical-object particularization.

In some embodiments, the set of performance objectives can include one or more of (a) a fitness goal of the user, (b) a business objective, (c) a relationship-building goal, and/or (d) a household task to be performed (e.g., cooking, cleaning, organizing sets of movable objects). In some embodiments, the user interface 162 includes a set of selection options for specifying particular classes of objectives (e.g., “Fitness Objectives 164-a”; “Work Objectives 164-b”; and/or “Life Objectives 164-c”). In some embodiments, in accordance with selecting a particular class of objective, the AI system 110 is configured to provide additional user interfaces to guide the user through the objective selection process.

In some embodiments, a selection of a particular object as a physical landmark causes one or more cameras of the AI system 110 to gather additional data about the location to which the controller 106 is directed for a particular amount of time (e.g., five seconds).

In some embodiments, when a user selects the particular object as the physical landmark, the AI system 110 causes presentation of user interface elements for the user to provide more information about the physical landmark. In some embodiments, the AI system is configured to provide example images about the selected physical landmarks, and is configured to provide questions and/or other information to the user regarding the selection of the physical object.

FIG. 1B shows another point in the sequence after the wearer has provided input at user interface 162. In some embodiments, based on the input provided at user interface 162, the AI system 110 identifies one or more performance objectives and causes presentation of user interface 166 within the field of view 102. In some embodiments, user interface 166 is a subsequent user interface in the interaction sequence that follows user interface 162 and indicates the identified objective (e.g., “Objective Identified – Lose Five Pounds”), along with selectable options (e.g., visual action loop option 168-a, suggested activity actions option 168-b, and suggested nutrition actions option 168-c) for the wearer to further refine the visual action loop, suggested activities, or suggested nutrition associated with the identified objective. In accordance with some embodiments, the AI system 110 may cause additional selection of data from the particularization module 154 in accordance with a determination about a particular option for an intermediate task.

FIG. 1B shows another point in the sequence after the wearer has provided input at user interface 162. In some embodiments, based on the input provided at user interface 162, the AI system 110 identifies one or more performance objectives and causes presentation of user interface 166 within the field of view 102. In some embodiments, user interface 166 is a subsequent user interface in the interaction sequence that follows user interface 162 and indicates the identified objective (e.g., “Objective Identified – Lose Five Pounds”), along with selectable options (e.g., visual action loop option 168-a, suggested activity actions option 168-b, and suggested nutrition actions option 168-c) for the wearer to further refine the visual action loop, suggested activities, or suggested nutrition associated with the identified objective. In accordance with some embodiments, the AI system 110 may cause the particularization module 154 (introduced above with reference to FIG. 1A) to gather additional data relevant to a selected intermediate task, for example by prompting the wearer for further information about a recognized physical object in the wearer’s surroundings.

FIG. 1C shows another point in the sequence following presentation of user interface 166. In some embodiments, user interface 170 is a further subsequent user interface in the interaction sequence, presented by the particularization module 154, that prompts the wearer to select a portion of a recognized physical object (e.g., the chair 104) in the wearer’s physical surroundings. FIG. 1D shows another point in the sequence after the wearer has caused identification of a particular objective. In some embodiments, FIG. 1D depicts user interface 176 including prompt 178, which is yet another subsequent user interface in the same interaction sequence that prompts the wearer to provide additional data about the physical landmark (e.g., an additional portion of the chair 104) using the controller 106 directed at the location of selection indicator 174-a. In some embodiments, user interfaces 162, 166, 170, and 176 are successive user interfaces presented at successive stages of the same interaction sequence with the AI system 110. In accordance with some embodiments, upon the selection of the chair 104, the AI system 110 is provided with a prompt from the user regarding one or more of (i) a set of performance objectives of the user, (ii) context data associated with the user, and/or (iii) context data associated with the imaging data.

FIG. 1E shows another point in the sequence after the user has caused identification of the particular objective. In the portion of the sequence shown in FIG. 1E, the AI system 110 is providing a visual representation 184 of the user performing an activity (e.g., lifting weights) that is identified as an intermediate task for accomplishing an objective that was previously identified. Based on the detection of the activity by a wearable device (e.g., the wrist-wearable device 326), the AI system 110 may cause presentation of a user interface element 180 related to the user’s performance of the physical activity (e.g., “Add this activity to the list of intermediate tasks?”).

In accordance with some embodiments, once the AI system 110 identifies a particular objective of the user, it can cause identification of one or more intermediate tasks that must be performed to accomplish the particular object (e.g., performing a particular activity as part of a predefined workout routine, eating a particular meal). In some embodiments, the intermediate tasks are identified based on loop particularization data, and/or other personalized context data about the device and/or the user of the device.

In accordance with some embodiments, the AI system 110 allows the controller 106 to select locations where the user can cause gathering of additional image data of particular physical landmarks (e.g., interactivity “hotspots,” locations, or other objects that could be better utilized by the system to generate visual action loops when more details are gathered about the objects).

FIG. 1F depicts a visual action loop UI 190 for a fitness workout application, in accordance with some embodiments. The visual action loop UI 190 presents a circular workflow connecting multiple activity cards that guide the wearer through a sequence of exercises. A first activity card 192-1 displays information for a first activity (e.g., bicep curls), including sets completed, repetitions, and weight. The first activity card 192-1 includes a first view simulated repetition button 194-1 that, when selected, causes presentation of a visual representation of the wearer performing the exercise with correct form. The first activity card 192-1 also includes a first view personal best button 196-1 that, when selected, causes presentation of historical performance data for the activity.

The visual action loop UI 190 further includes a second activity card 192-2 displaying information for a second activity (e.g., shoulder press). The second activity card 192-2 includes a second view simulated repetition button 194-2 and a second view personal best button 196-2. The visual action loop UI 190 presents visual representations of the wearer performing the respective exercises, providing real-time guidance during workout sessions. A hydration progress tracker 198 is positioned within the visual action loop UI 190, displaying a workout summary that includes total duration, calories burned, number of exercises, and progress toward completion of the workout routine.

FIG. 1G illustrates a block diagram of the AI system 110 configured to provide visual action loops for accomplishing user goals in a social or professional context, in accordance with some embodiments. The figure depicts a user 302 wearing an AR device 328 while in a social setting with a first person 131-1 and a second person 131-2. The AI system 110 detects, via one or more audio sensors and/or imaging sensors of the AR device 328, contextual information about the social setting.

In accordance with some embodiments, the AI system 110 can cause presentation, via the AR device 328, of personalized status updates to the wearer relating to the wearer’s progress toward one or more identified performance objectives. In some embodiments, the personalized status updates can be generated based on the loop particularization data 130 (e.g., the performance objectives 132, the user context data 134, and/or the image context data 136), and/or sensor data received from the wrist-wearable device 326 or one or more third-party sensor devices (e.g., a glucose monitor or heart rate monitor). In some embodiments, the personalized status updates can include one or more of: (i) an indication of progress toward a respective performance objective (e.g., a percentage of a fitness goal completed, a number of intermediate tasks completed); (ii) a comparison between current progress and a target rate of progress; (iii) a reminder of a next intermediate task to be performed; (iv) a recommendation to adjust an activity based on detected adherence to previously scheduled or recommended activities; and/or (v) a summary of completed intermediate tasks over a defined time period (e.g., a daily or weekly summary).

In some embodiments, the personalized status updates can be presented in various forms, including a progress tracker (e.g., the hydration progress tracker 198 of FIG. 1F or the networking summary 149 of FIG. 1H), a notification surfaced within the field of view of the wearer, and/or an audio output, depending on the wearer’s context. In some embodiments, the personalized status updates can be triggered proactively by the AI system 110 based on time-based factors (e.g., end of day, end of week), location-based factors (e.g., the wearer arriving at a gym or returning home), and/or completion of a particular intermediate task.

The AR device 328 presents a notification interface 133 to the user 302, which displays contextual information based on the detected environment. In this instance, the notification interface 133 indicates that a topic related to the user’s expertise (e.g., cloud architecture) has been detected in a nearby conversation. The notification interface 133 also includes an action loop button 135 that allows the user 302 to access additional visual action loop information related to the detected context. In accordance with some embodiments, proactive triggers can include what the user is seeing (visual), what the user is hearing (audio), where the user is (location), and time-based factors, ensuring proactive interactions that do not require the user initiating.

FIG. 1H depicts a visual action loop UI 141 for facilitating networking interactions, in accordance with some embodiments. The visual action loop UI 141 includes a join conversation card 143-1 that displays conversation details 145-1 indicating a topic and relevance level. The join conversation card 143-1 includes a view talking points button 147-1 that, when selected, causes presentation of suggested talking points relevant to the detected conversation topic. The visual action loop UI 141 further includes an exchange contacts card 143-2 that displays contact exchange details 145-2 indicating engagement metrics and connection information.

A networking summary 149 is displayed within the visual action loop UI 141, showing statistics including conversations joined, new contacts made, and follow-up actions. The networking summary 149 provides the wearer with an overview of networking progress relative to relationship-building objectives identified by the AI system 110.

FIG. 1I illustrates a portion of a sequence of interactions with the AI system 110 configured to provide visual action loops for health-conscious food suggestions, in accordance with some embodiments. The figure depicts a field of view of a wearer of an AR device viewing a food service area containing a first food tray 151-1 and a second food tray 151-2. If the user’s goal is to lose weight, the system can recognize grilled chicken next to fried chicken and encourage the user to go for the healthier choice. A recommendation prompt 153 is presented within the field of view, providing guidance to the wearer based on previously identified performance objectives.

The AI system 110 can suggest healthier food alternatives, such as suggesting cauliflower rice instead of regular rice, or suggesting an alternative dish instead of frozen chicken nuggets. The recommendation prompt 153 directs attention toward a healthier food choice, which may be indicated with a selection indicator or visual highlight.

FIG. 1J illustrates a system diagram depicting the AI system 110 configured to provide visual action loops for accomplishing user goals related to nutrition, in accordance with some embodiments. The AR device 328 presents a user interface element 155 and a visual action loop 157 to the user 302. The visual action loop 157 displays nutritional guidance indicating that the portions shown in the visualization would provide the user 302 with appropriate nutrients to meet their calorie goals.

In accordance with some embodiments, the AI system 110 can provide hydration reminders to the wearer. The system can indicate that the user has only consumed a certain number of cups of water today, and upon recognizing a jug of water in front of the user, prompt the user to drink every 15 minutes. The AI system 110 can recognize a water container 192 within the physical surroundings and cause presentation of a hydration indicator 194 prompting the wearer to consume water.

In accordance with some embodiments, the AI system 110 can cause presentation, via the AR device 328, of a multi-day meal plan (e.g., a weekly meal plan) as a visual action loop personalized for the user 302. The weekly meal plan can include recommended breakfast, lunch, and dinner menus, along with recipes and snack suggestions, for each day of a planning period. The weekly meal plan can be generated by the AI system 110 based on the performance objectives 140 (e.g., a fitness goal to lose five pounds), the user context data 134 (e.g., dietary preferences, workout history, daily calories burned), and/or the image context data 136 (e.g., food items recognized in the wearer’s surroundings, contents of the wearer’s refrigerator or pantry). In some embodiments, the visual action loop for the weekly meal plan includes a plurality of meal cards, each meal card corresponding to a respective meal in the planning period, and selection of a meal card causes presentation of recipe guidance, ingredient lists, and preparation steps for the respective meal.

In some embodiments, the AI system 110 can generate a shopping list based on the ingredients required for the meal plan and cause presentation of the shopping list via a grocery or shopping application when the wearer is recognized as being in a retail environment. In some embodiments, the AI system 110 can provide personalized status updates relating to the wearer’s progress through the meal plan (e.g., a reminder to consume a recovery shake after a workout session, or a notification suggesting a particular lunch or dinner that aligns with the wearer’s fitness goals). In some embodiments, the meal plan can be updated dynamically based on the wearer’s adherence to prior meals, sensor data received from a third-party sensor device, and/or changes to the performance objectives 140 of the user 302.

In accordance with some embodiments, the AI system 110 can provide time-based triggers for visual action loops. The system can track time and history throughout the day, and determine that the user has been sitting for about 4 hours and is overdue for exercise, particularly when there is a pull-up bar or other exercise equipment in front of the user.

In accordance with some embodiments, the AI system 110 can cause a calendar or scheduling application to automatically schedule activities on a calendar associated with the user 302 in furtherance of the performance objectives 140. For example, the AI system 110 can automatically place workout sessions, grocery shopping trips, meal-prep sessions, and/or other intermediate tasks identified by the task identification module 156 at respective times on the user’s calendar, based on availability information provided by the user 302 (e.g., open time slots, preferred workout times, days per week the user wants to work out), the user context data 134, and/or the image context data 136. In some embodiments, an automatically scheduled activity can serve as a time-based trigger that causes presentation, at the AR device 328, of a visual action loop associated with the scheduled activity at the scheduled time. In some embodiments, the AI system 110 can adapt the schedule of activities over time based on the user’s adherence to previously scheduled activities and/or sensor data received from the wrist-wearable device 326 or a third-party sensor device, such that subsequent activities are rescheduled or substituted to help the user realize the performance objectives 140.

In accordance with some embodiments, the AI system 110 can integrate data from third-party sensor devices. Third-party sensor integration can include glucose monitors and heart rate monitors, which could be implemented as a watch. The sensor data from these third-party devices can be used to inform the generation of visual action loops and provide more personalized recommendations to the wearer.

In accordance with some embodiments, the AI system 110 can detect audio context data 138 from the physical surroundings of the wearer to proactively trigger visual action loops. There is rich context available in audio information, especially when hearing people talking, providing descriptive information without having to recognize objects and predict connections. Standing outside with eyes closed, a user can usually localize where they are based on sounds—how loud the traffic is, whether people are walking by, whether there is nature or water—which can localize the user better than GPS signals.

Audio signals can include chime sounds when a user walks through a door, sounds of a hardware store such as heavy carts going by, keys being made, or salespeople talking, as well as localization sounds including traffic, people walking, nature, and water. Based on the detected audio context, the AI system 110 can proactively present visual action loops without requiring explicit user initiation.

In accordance with some embodiments, the AI system 110 can detect audio cues indicating that the wearer needs assistance. The system can detect pauses or audible cues when the user is trying to remember something, such as when the user asks “Who was the actor in that movie?” and pauses, triggering the AI to provide the answer.

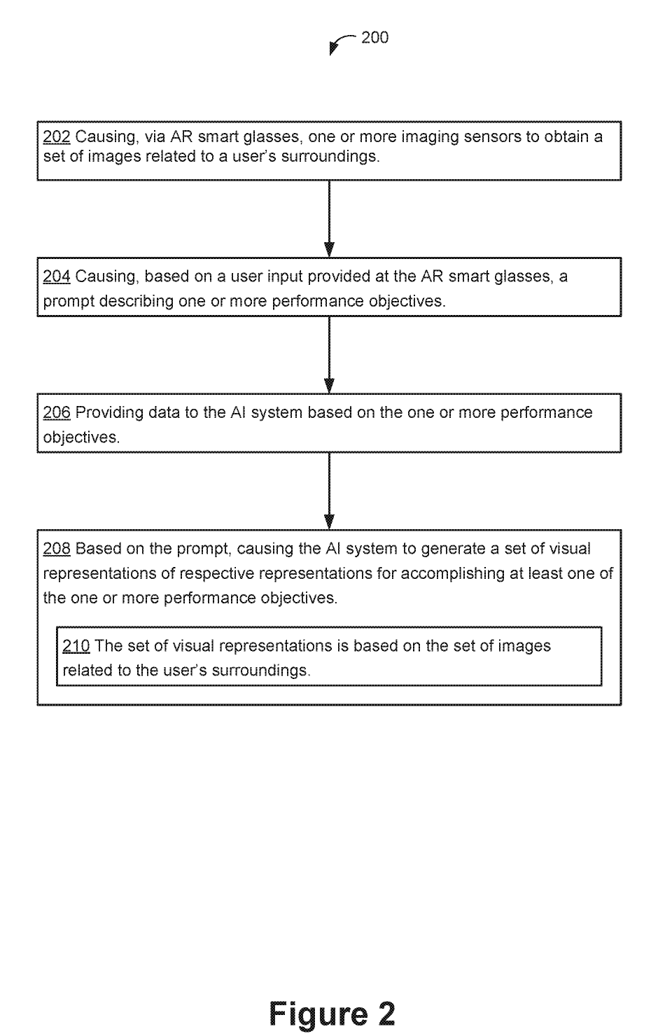

(A1) FIG. 2 shows a flow chart depicting a method 200 for generating a visual action plan for a set of actions that a user is seeking to accomplish, in accordance with some embodiments.

The method 200 includes causing (202), via an AR device, one or more imaging sensors to obtain a set of images related to a user’s surroundings (e.g., images of portions of the user’s home or work space). For example, imaging sensors of the AR device 328 may be configured to gather data about the user’s physical surroundings.

The method 200 includes causing (204), based on a user input provided at the AR device, a prompt describing one or more performance objectives. As described herein, a performance objective is a specific, measurable, achievable, relevant, and time-bound goal that defines what an individual, team, and/or organization that the user wishes to accomplish (e.g., a goal to lose five pounds in two months, a task to gather ingredients for a recipe, etc.).

The method 200 includes providing (206) data to the AI system based on the one or more performance objectives. For example, in some embodiments, raw text from the user input is provided to the AI system. In accordance with some embodiments, an organized data structure is generated based on content of the prompt.

The method 200 includes, based on the prompt, causing (208) the AI system to generate a set of visual representations of respective representations for accomplishing at least one of the one or more performance objectives.

The set of visual representations is based on the set of images related to the user’s surroundings (210). For example, FIG. 1E shows a visual representation 184 being presented based on the user capturing the image data about the locations 110-A to 110-C, as shown in FIGS. 1A to 1C.

(A2) In some embodiments of A1, a respective performance objective of the one or more performance objectives is one or more of: (i) a fitness goal of the user, (ii) a business objective of the user, (iii) a relationship-building goal, and/or (iv) a household task to be performed.

(A3) In some embodiments of A1 or A2, the method 200 includes identifying one or more respective performance activities of the set of performance objectives based on behavioral data associated with the user, and the method 200 includes causing, using the AI system, generation of respective visual representations of the one or more respective performance activities. For example, in FIG. 1E, the AI system causes presentation, at the head-wearable device, of a visual representation based on the user’s particular objective.

(A4) In some embodiments of any one of A1 to A3, the method 200 includes determining one or more intermediate objectives required for completing the set of one or more performance objectives, and the method 200 includes generating respective visual representations of each of the one or more intermediate objectives as part of generating the set of visual representations. For example, in FIG. 1C, the AI system causes a prompt to be provided to the user regarding the user-intended goal (e.g., “how many calories would you like to eat per day”; “how much time do you have to cook the recipe”).

(A5) In some embodiments of any one of A1 to A4, the method 200 includes automatically identifying a predefined actionable objective based on the one or more performance objectives described by the prompt.

(A6) In some embodiments of any one of A1 to A5, the method 200 includes, based on determining that additional personalized user data would be relevant for providing a visual action plan to the user, causing another input to the AI system.

(A7) In some embodiments of any one of A1 to A6, the visual representation includes a visualization of the user performing the activity in a location within their home.

(A8) In some embodiments of any one of A1 to A7, the method 200 includes identifying that the user is not performing a portion of the exercise correctly. In some embodiments, the method 200 includes, in accordance with identifying that the user is not performing the portion of the exercise correctly, providing one or more indications within the visualization related to correcting the performance of the activity by the user.

(A9) In some embodiments of any one of A1 to A8, the method includes recognizing, via the one or more imaging sensors, one or more food items within the physical surroundings of the user, and in accordance with recognizing the one or more food items, causing presentation of a visual representation suggesting a healthier food alternative to at least one of the one or more food items, wherein the healthier food alternative is determined based on the one or more performance objectives of the user. For example, in FIG. 1I, the AI system causes presentation of a recommendation prompt 153 suggesting a healthier food option based on the user’s objective to lose weight.

(A10) In some embodiments of A9, the visual representation suggesting the healthier food alternative includes a portioned serving visualization indicating a recommended portion size for the healthier food alternative, wherein the recommended portion size is determined based on nutrient goals associated with the one or more performance objectives of the user. For example, in FIG. 1J, the visual action loop 157 displays nutritional guidance indicating appropriate portions to meet calorie goals.

(A11) In some embodiments of any one of A1 to A10, the method includes recognizing, via the one or more imaging sensors, a water container within the physical surroundings of the user, determining, based on data associated with the user, a hydration level of the user, and in accordance with determining that the hydration level is below a threshold, causing presentation of a visual representation prompting the user to consume water from the water container.

(A12) In some embodiments of any one of A1 to A11, the method includes determining, based on sensor data associated with the user, that the user has been sedentary for a duration exceeding a threshold duration, and in accordance with determining that the user has been sedentary for the duration exceeding the threshold duration, causing presentation of a visual representation prompting the user to perform a physical activity, wherein the visual representation is based on one or more physical objects within the physical surroundings of the user that are associated with performing the physical activity.

(A13) In some embodiments of any one of A1 to A12, the method includes receiving sensor data from a third-party sensor device worn by the user, wherein the third-party sensor device comprises one or more of a glucose monitor or a heart rate monitor, and generating the set of visual representations based at least in part on the sensor data received from the third-party sensor device.

(A14) In some embodiments of A13, the method includes causing presentation of a visual representation depicting the user performing a particular activity, wherein the visual representation includes an overlay of performance metrics derived from the sensor data received from the third-party sensor device, and wherein the performance metrics are displayed in real-time relative to the user’s movements during the particular activity. For example, in FIG. 1F, the visual action loop UI 190 can display workout metrics derived from third-party sensor data.

(B1) In some embodiments, a method includes, at an AR device in electronic communication with an AI system, detecting, via one or more audio sensors of the AR device, audio data from the physical surroundings of the user, determining, based on the audio data, an audio context associated with the physical surroundings of the user, identifying, based on the audio context and without requiring explicit user initiation, that a proactive visual action loop should be presented to the user, and in accordance with identifying that the proactive visual action loop should be presented, causing the AI system to generate a set of visual representations of respective activities for accomplishing at least one performance objective associated with the audio context. For example, as shown in FIG. 1G, the AI system 110 can detect audio context from a social setting and proactively present a notification interface 133.

(B2) In some embodiments of B1, the audio context comprises one or more of (i) sounds associated with a retail environment including sounds of doors opening, shopping carts, or point-of-sale transactions, (ii) sounds associated with a fitness environment including sounds of exercise equipment, music, or physical exertion, (iii) sounds associated with a food preparation environment including sounds of cooking, running water, or kitchen appliances, or (iv) ambient sounds that indicate a location type including traffic sounds, nature sounds, or crowd noise.

(B3) In some embodiments of B1 or B2, identifying that the proactive visual action loop should be presented comprises detecting, based on the audio data, one or more audio cues indicating that the user is attempting to recall information, wherein the one or more audio cues comprise one or more of a pause in speech or a verbal indication of uncertainty, and in accordance with detecting the one or more audio cues, causing the AI system to generate a visual representation providing information relevant to a context of the audio data.

(B4) In some embodiments of any one of B1 to B3, the one or more additional contextual factors comprise time-based data including one or more of (i) a time of day, (ii) a duration of an activity being performed by the user, or (iii) a duration since a previous activity was performed by the user.

(B5) In some embodiments of any one of B1 to B4, the method includes detecting, based on the audio data, that the user has completed an activity associated with a first performance objective, and in accordance with detecting that the user has completed the activity, causing presentation of a visual representation suggesting a next activity for accomplishing a second performance objective or a subsequent step for accomplishing the first performance objective.

(B6) In some embodiments of any one of B1 to B5, the set of visual representations includes a visual action loop user interface comprising a plurality of activity cards, each activity card corresponding to a respective intermediate activity for accomplishing the at least one performance objective, visual representations of the user performing each respective intermediate activity, and a progress tracker displaying progress toward completion of the at least one performance objective. For example, in FIG. 1F, the visual action loop UI 190 includes a first activity card 192-1 and a second activity card 192-2, along with a hydration progress tracker 198. In another example, in FIG. 1H, the visual action loop UI 141 includes a join conversation card 143-1, an exchange contacts card 143-2, and a networking summary 149.

(C1) In accordance with some embodiments, a system that includes one or more wrist wearable devices and a pair of augmented-reality glasses, and the system is configured to perform operations corresponding to any of A1-A14, or B1-B6.

(D1) In accordance with some embodiments, a non-transitory computer readable storage medium including instructions that, when executed by a computing device in communication with a pair of augmented-reality glasses, cause the computer device to perform operations corresponding to any of A1-A14, or B1-B6.

(D1) In accordance with some embodiments, a method of operating a pair of augmented-reality glasses, including operations that correspond to any of A1-A14, or B1-B6.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

### Example Extended-Reality Systems

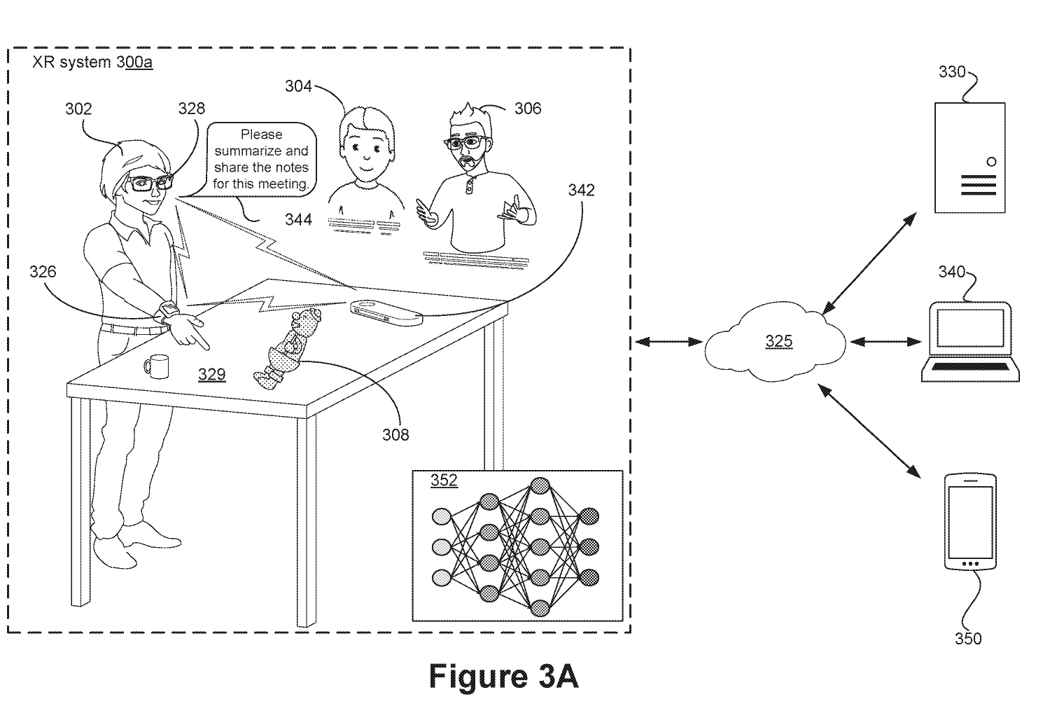

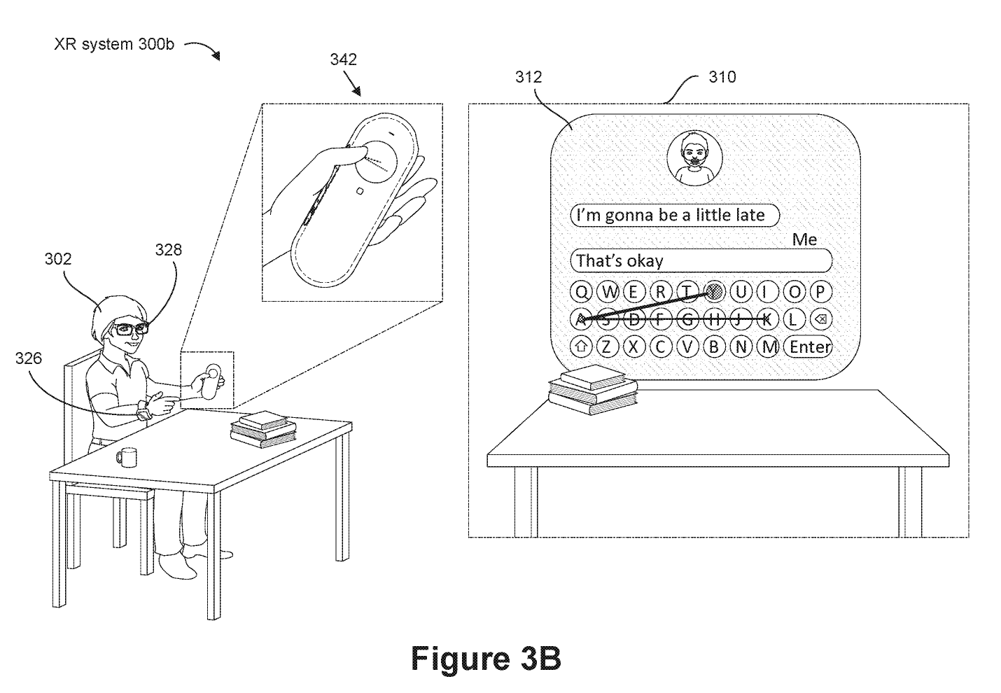

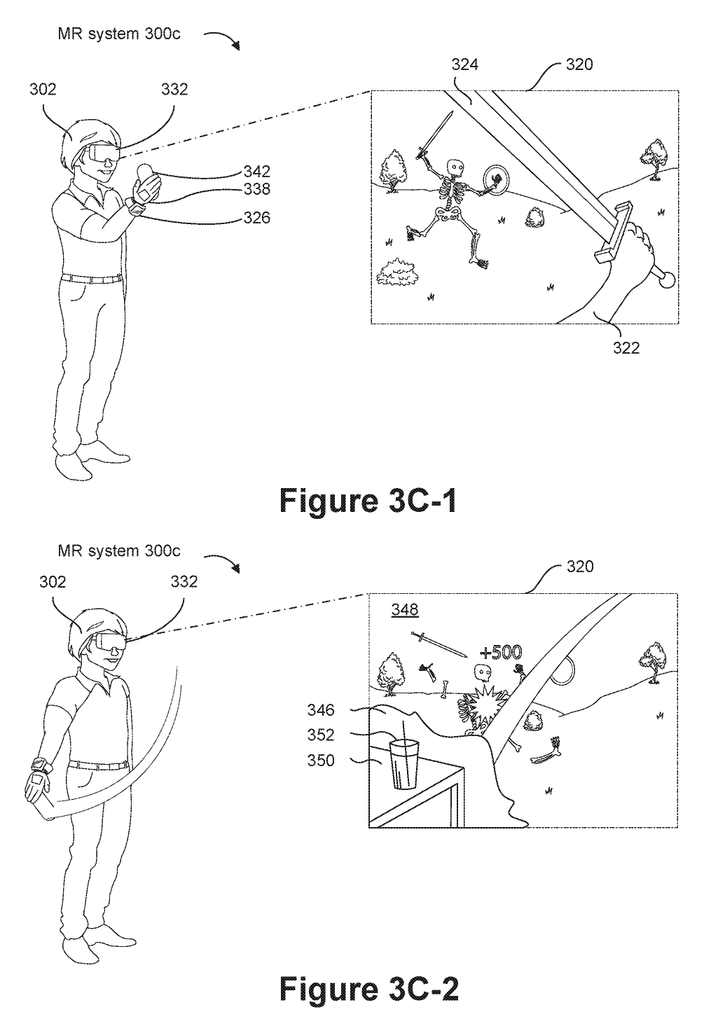

FIGS. 3A, 3B, 3C-1 and 3C-2, illustrate example XR systems that include AR and MR systems, in accordance with some embodiments. FIG. 3A shows a first XR system 300a and first example user interactions using a wrist-wearable device 326, a head-wearable device (e.g., AR device 328), and/or a HIPD 342. FIG. 3B shows a second XR system 300b and second example user interactions using a wrist-wearable device 326, AR device 328, and/or an HIPD 342. FIGS. 3C-1 and 3C-2 show a third MR system 300c and third example user interactions using a wrist-wearable device 326, a head-wearable device (e.g., an MR device such as a VR device), and/or an HIPD 342. As the skilled artisan will appreciate upon reading the descriptions provided herein, the above-example AR and MR systems (described in detail below) can perform various functions and/or operations.

The wrist-wearable device 326, the head-wearable devices, and/or the HIPD 342 can communicatively couple via a network 325 (e.g., cellular, near field, Wi-Fi, personal area network, wireless LAN). Additionally, the wrist-wearable device 326, the head-wearable device, and/or the HIPD 342 can also communicatively couple with one or more servers 330, computers 340 (e.g., laptops, computers), mobile devices 350 (e.g., smartphones, tablets), and/or other electronic devices via the network 325 (e.g., cellular, near field, Wi-Fi, personal area network, wireless LAN). Similarly, a smart textile-based garment, when used, can also communicatively couple with the wrist-wearable device 326, the head-wearable device(s), the HIPD 342, the one or more servers 330, the computers 340, the mobile devices 350, and/or other electronic devices via the network 325 to provide inputs.

Turning to FIG. 3A, a user 302 is shown wearing the wrist-wearable device 326 and the AR device 328 and having the HIPD 342 on their desk. The wrist-wearable device 326, the AR device 328, and the HIPD 342 facilitate user interaction with an AR environment. In particular, as shown by the first AR system 300a, the wrist-wearable device 326, the AR device 328, and/or the HIPD 342 cause presentation of one or more avatars 304, digital representations of contacts 306, and virtual objects 308. As discussed below, the user 302 can interact with the one or more avatars 304, digital representations of the contacts 306, and virtual objects 308 via the wrist-wearable device 326, the AR device 328, and/or the HIPD 342. In addition, the user 302 is also able to directly view physical objects in the environment, such as a physical table, through transparent lens(es) and waveguide(s) of the AR device 328. Alternatively, an MR device could be used in place of the AR device 328 and a similar user experience can take place, but the user would not be directly viewing physical objects in the environment, such as table 329, and would instead be presented with a virtual reconstruction of the table 329 produced from one or more sensors of the MR device (e.g., an outward facing camera capable of recording the surrounding environment).

The user 302 can use any of the wrist-wearable device 326, the AR device 328 (e.g., through physical inputs at the AR device and/or built-in motion tracking of a user’s extremities), a smart-textile garment, externally mounted extremity tracking device, the HIPD 342 to provide user inputs, etc. For example, the user 302 can perform one or more hand gestures that are detected by the wrist-wearable device 326 (e.g., using one or more EMG sensors and/or IMUs built into the wrist-wearable device) and/or AR device 328 (e.g., using one or more image sensors or cameras) to provide a user input. Alternatively, or additionally, the user 302 can provide a user input via one or more touch surfaces of the wrist-wearable device 326, the AR device 328, and/or the HIPD 342, and/or voice commands captured by a microphone of the wrist-wearable device 326, the AR device 328, and/or the HIPD 342. The wrist-wearable device 326, the AR device 328, and/or the HIPD 342 include an artificially intelligent digital assistant to help the user in providing a user input (e.g., completing a sequence of operations, suggesting different operations or commands, providing reminders, confirming a command). For example, the digital assistant can be invoked through an input occurring at the AR device 328 (e.g., via an input at a temple arm of the AR device 328). In some embodiments, the user 302 can provide a user input via one or more facial gestures and/or facial expressions. For example, cameras of the wrist-wearable device 326, the AR device 328, and/or the HIPD 342 can track the user 302’s eyes for navigating a user interface.

The wrist-wearable device 326, the AR device 328, and/or the HIPD 342 can operate alone or in conjunction to allow the user 302 to interact with the AR environment. In some embodiments, the HIPD 342 is configured to operate as a central hub or control center for the wrist-wearable device 326, the AR device 328, and/or another communicatively coupled device. For example, the user 302 can provide an input to interact with the AR environment at any of the wrist-wearable device 326, the AR device 328, and/or the HIPD 342, and the HIPD 342 can identify one or more back-end and front-end tasks to cause the performance of the requested interaction and distribute instructions to cause the performance of the one or more back-end and front-end tasks at the wrist-wearable device 326, the AR device 328, and/or the HIPD 342. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 342 can perform the back-end tasks and provide the wrist-wearable device 326 and/or the AR device 328 operational data corresponding to the performed back-end tasks such that the wrist-wearable device 326 and/or the AR device 328 can perform the front-end tasks. In this way, the HIPD 342, which has more computational resources and greater thermal headroom than the wrist-wearable device 326 and/or the AR device 328, performs computationally intensive tasks and reduces the computer resource utilization and/or power usage of the wrist-wearable device 326 and/or the AR device 328.

In the example shown by the first AR system 300a, the HIPD 342 identifies one or more back-end tasks and front-end tasks associated with a user request to initiate an AR video call with one or more other users (represented by the avatar 304 and the digital representation of the contact 306) and distributes instructions to cause the performance of the one or more back-end tasks and front-end tasks. In particular, the HIPD 342 performs back-end tasks for processing and/or rendering image data (and other data) associated with the AR video call and provides operational data associated with the performed back-end tasks to the AR device 328 such that the AR device 328 performs front-end tasks for presenting the AR video call (e.g., presenting the avatar 304 and the digital representation of the contact 306).

In some embodiments, the HIPD 342 can operate as a focal or anchor point for causing the presentation of information. This allows the user 302 to be generally aware of where information is presented. For example, as shown in the first AR system 300a, the avatar 304 and the digital representation of the contact 306 are presented above the HIPD 342. In particular, the HIPD 342 and the AR device 328 operate in conjunction to determine a location for presenting the avatar 304 and the digital representation of the contact 306. In some embodiments, information can be presented within a predetermined distance from the HIPD 342 (e.g., within five meters). For example, as shown in the first AR system 300a, virtual object 308 is presented on the desk some distance from the HIPD 342. Similar to the above example, the HIPD 342 and the AR device 328 can operate in conjunction to determine a location for presenting the virtual object 308. Alternatively, in some embodiments, presentation of information is not bound by the HIPD 342. More specifically, the avatar 304, the digital representation of the contact 306, and the virtual object 308 do not have to be presented within a predetermined distance of the HIPD 342. While an AR device 328 is described working with an HIPD, an MR headset can be interacted with in the same way as the AR device 328.

User inputs provided at the wrist-wearable device 326, the AR device 328, and/or the HIPD 342 are coordinated such that the user can use any device to initiate, continue, and/or complete an operation. For example, the user 302 can provide a user input to the AR device 328 to cause the AR device 328 to present the virtual object 308 and, while the virtual object 308 is presented by the AR device 328, the user 302 can provide one or more hand gestures via the wrist-wearable device 326 to interact and/or manipulate the virtual object 308. While an AR device 328 is described working with a wrist-wearable device 326, an MR headset can be interacted with in the same way as the AR device 328.

### Integration of Artificial Intelligence with XR Systems

FIG. 3A illustrates an interaction in which an artificially intelligent virtual assistant can assist in requests made by a user 302. The AI virtual assistant can be used to complete open-ended requests made through natural language inputs by a user 302. For example, in FIG. 3A the user 302 makes an audible request 344 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 3A also illustrates an example neural network 352 used in Artificial Intelligence applications. Uses of Artificial Intelligence (AI) are varied and encompass many different aspects of the devices and systems described herein. AI capabilities cover a diverse range of applications and deepen interactions between the user 302 and user devices (e.g., the AR device 328, an MR device 332, the HIPD 342, the wrist-wearable device 326). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user’s request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 302 can interact with an AI model through natural language inputs captured by a voice sensor, text inputs, or any other input modality that accepts natural language and/or a corresponding voice sensor module. In another instance, input is provided by tracking the eye gaze of a user 302 via a gaze tracker module. Additionally, the AI model can also receive inputs beyond those supplied by a user 302. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors’ data can be retrieved entirely from a single device (e.g., AR device 328) or from multiple devices that are in communication with each other (e.g., a system that includes at least two of an AR device 328, an MR device 332, the HIPD 342, the wrist-wearable device 326, etc.). The AI model can also access additional information (e.g., one or more servers 330, the computers 340, the mobile devices 350, and/or other electronic devices) via a network 325.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 328, an MR device 332, the HIPD 342, the wrist-wearable device 326) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 328, an MR device 332, the HIPD 342, the wrist-wearable device 326), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 342), haptic feedback can provide information to the user 302. An AI model can also use the inputs described above to determine the appropriate modality and device(s) to present content to the user (e.g., a user walking on a busy road can be presented with an audio output instead of a visual output to avoid distracting the user 302).

### Example Augmented Reality Interaction

FIG. 3B shows the user 302 wearing the wrist-wearable device 326 and the AR device 328 and holding the HIPD 342. In the second AR system 300b, the wrist-wearable device 326, the AR device 328, and/or the HIPD 342 are used to receive and/or provide one or more messages to a contact of the user 302. In particular, the wrist-wearable device 326, the AR device 328, and/or the HIPD 342 detect and coordinate one or more user inputs to initiate a messaging application and prepare a response to a received message via the messaging application.

In some embodiments, the user 302 initiates, via a user input, an application on the wrist-wearable device 326, the AR device 328, and/or the HIPD 342 that causes the application to initiate on at least one device. For example, in the second AR system 300b the user 302 performs a hand gesture associated with a command for initiating a messaging application (represented by messaging user interface 312); the wrist-wearable device 326 detects the hand gesture; and, based on a determination that the user 302 is wearing the AR device 328, causes the AR device 328 to present a messaging user interface 312 of the messaging application. The AR device 328 can present the messaging user interface 312 to the user 302 via its display (e.g., as shown by user 302’s field of view 310). In some embodiments, the application is initiated and can be run on the device (e.g., the wrist-wearable device 326, the AR device 328, and/or the HIPD 342) that detects the user input to initiate the application, and the device provides another device operational data to cause the presentation of the messaging application. For example, the wrist-wearable device 326 can detect the user input to initiate a messaging application, initiate and run the messaging application, and provide operational data to the AR device 328 and/or the HIPD 342 to cause presentation of the messaging application. Alternatively, the application can be initiated and run at a device other than the device that detected the user input. For example, the wrist-wearable device 326 can detect the hand gesture associated with initiating the messaging application and cause the HIPD 342 to run the messaging application and coordinate the presentation of the messaging application.

Further, the user 302 can provide a user input provided at the wrist-wearable device 326, the AR device 328, and/or the HIPD 342 to continue and/or complete an operation initiated at another device. For example, after initiating the messaging application via the wrist-wearable device 326 and while the AR device 328 presents the messaging user interface 312, the user 302 can provide an input at the HIPD 342 to prepare a response (e.g., shown by the swipe gesture performed on the HIPD 342). The user 302’s gestures performed on the HIPD 342 can be provided and/or displayed on another device. For example, the user 302’s swipe gestures performed on the HIPD 342 are displayed on a virtual keyboard of the messaging user interface 312 displayed by the AR device 328.

In some embodiments, the wrist-wearable device 326, the AR device 328, the HIPD 342, and/or other communicatively coupled devices can present one or more notifications to the user 302. The notification can be an indication of a new message, an incoming call, an application update, a status update, etc. The user 302 can select the notification via the wrist-wearable device 326, the AR device 328, or the HIPD 342 and cause presentation of an application or operation associated with the notification on at least one device. For example, the user 302 can receive a notification that a message was received at the wrist-wearable device 326, the AR device 328, the HIPD 342, and/or other communicatively coupled device and provide a user input at the wrist-wearable device 326, the AR device 328, and/or the HIPD 342 to review the notification, and the device detecting the user input can cause an application associated with the notification to be initiated and/or presented at the wrist-wearable device 326, the AR device 328, and/or the HIPD 342.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 328 can present to the user 302 game application data and the HIPD 342 can use a controller to provide inputs to the game. Similarly, the user 302 can use the wrist-wearable device 326 to initiate a camera of the AR device 328, and the user can use the wrist-wearable device 326, the AR device 328, and/or the HIPD 342 to manipulate the image capture (e.g., zoom in or out, apply filters) and capture image data.

While an AR device 328 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user’s hand or other suitable surface (e.g., a table, whiteboard). In yet another embodiment, information may also be provided by locally dimming portions of a lens to emphasize portions of the environment in which the user’s attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 3C-1 and 3C-2, the user 302 is shown wearing the wrist-wearable device 326 and an MR device 332 (e.g., a device capable of providing either an entirely VR experience or an MR experience that displays object(s) from a physical environment at a display of the device) and holding the HIPD 342. In the third AR system 300c, the wrist-wearable device 326, the MR device 332, and/or the HIPD 342 are used to interact within an MR environment, such as a VR game or other MR/VR application. While the MR device 332 presents a representation of a VR game (e.g., first MR game environment 320) to the user 302, the wrist-wearable device 326, the MR device 332, and/or the HIPD 342 detect and coordinate one or more user inputs to allow the user 302 to interact with the VR game.

In some embodiments, the user 302 can provide a user input via the wrist-wearable device 326, the MR device 332, and/or the HIPD 342 that causes an action in a corresponding MR environment. For example, the user 302 in the third MR system 300c (shown in FIG. 3C-1) raises the HIPD 342 to prepare for a swing in the first MR game environment 320. The MR device 332, responsive to the user 302 raising the HIPD 342, causes the MR representation of the user 322 to perform a similar action (e.g., raise a virtual object, such as a virtual sword 324). In some embodiments, each device uses respective sensor data and/or image data to detect the user input and provide an accurate representation of the user 302’s motion. For example, image sensors (e.g., SLAM cameras or other cameras) of the HIPD 342 can be used to detect a position of the HIPD 342 relative to the user 302’s body such that the virtual object can be positioned appropriately within the first MR game environment 320; sensor data from the wrist-wearable device 326 can be used to detect a velocity at which the user 302 raises the HIPD 342 such that the MR representation of the user 322 and the virtual sword 324 are synchronized with the user 302’s movements; and image sensors of the MR device 332 can be used to represent the user 302’s body, boundary conditions, or real-world objects within the first MR game environment 320.

In FIG. 3C-2, the user 302 performs a downward swing while holding the HIPD 342. The user 302’s downward swing is detected by the wrist-wearable device 326, the MR device 332, and/or the HIPD 342 and a corresponding action is performed in the first MR game environment 320. In some embodiments, the data captured by each device is used to improve the user’s experience within the MR environment. For example, sensor data of the wrist-wearable device 326 can be used to determine a speed and/or force at which the downward swing is performed and image sensors of the HIPD 342 and/or the MR device 332 can be used to determine a location of the swing and how it should be represented in the first MR game environment 320, which, in turn, can be used as inputs for the MR environment (e.g., game mechanics, which can use detected speed, force, locations, and/or aspects of the user 302’s actions to classify a user’s inputs (e.g., user performs a light strike, hard strike, critical strike, glancing strike, miss) or calculate an output (e.g., amount of damage)).

FIG. 3C-2 further illustrates that a portion of the physical environment is reconstructed and displayed at a display of the MR device 332 while the MR game environment 320 is being displayed. In this instance, a reconstruction of the physical environment 346 is displayed in place of a portion of the MR game environment 320 when object(s) in the physical environment are potentially in the path of the user (e.g., a collision with the user and an object in the physical environment are likely). Thus, this example MR game environment 320 includes (i) an immersive VR portion 348 (e.g., an environment that does not have a corollary counterpart in a nearby physical environment) and (ii) a reconstruction of the physical environment 346 (e.g., table in front of the user 302, and a cup on the table). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 326, the MR device 332, and/or the HIPD 342 are described as detecting user inputs, in some embodiments, user inputs are detected at a single device (with the single device being responsible for distributing signals to the other devices for performing the user input). For example, the HIPD 342 can operate an application for generating the first MR game environment 320 and provide the MR device 332 with corresponding data for causing the presentation of the first MR game environment 320, as well as detect the user 302’s movements (while holding the HIPD 342) to cause the performance of corresponding actions within the first MR game environment 320. Additionally or alternatively, in some embodiments, operational data (e.g., sensor data, image data, application data, device data, and/or other data) of one or more devices is provided to a single device (e.g., the HIPD 342) to process the operational data and cause respective devices to perform an action associated with processed operational data.

In some embodiments, the user 302 can wear a wrist-wearable device 326, wear an MR device 332, wear smart textile-based garments 338 (e.g., wearable haptic gloves), and/or hold an HIPD 342 device. In this embodiment, the wrist-wearable device 326, the MR device 332, and/or the smart textile-based garments 338 are used to interact within an MR environment (e.g., any AR or MR system described above in reference to FIGS. 3A–3B). While the MR device 332 presents a representation of an MR game (e.g., second MR game environment 320) to the user 302, the wrist-wearable device 326, the MR device 332, and/or the smart textile-based garments 338 detect and coordinate one or more user inputs to allow the user 302 to interact with the MR environment.

In some embodiments, the user 302 can provide a user input via the wrist-wearable device 326, an HIPD 342, the MR device 332, and/or the smart textile-based garments 338 that causes an action in a corresponding MR environment. In some embodiments, each device uses respective sensor data and/or image data to detect the user input and provide an accurate representation of the user 302’s motion. While four different input devices are shown (e.g., a wrist-wearable device 326, an MR device 332, an HIPD 342, and a smart textile-based garment 338) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 338) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user’s experience within the MR environment. Although not shown, the smart textile-based garments 338 can be used in conjunction with an MR device and/or an HIPD 342.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 3A–3C-2 provided above are intended to augment the description provided in reference to FIGS. 1A to 1E. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method, comprising:
at an augmented-reality (AR) device configured to present user interface elements positioned within a field of view of physical surroundings of a wearer of the AR device, wherein the AR device is in electronic communication with an AI system that comprises a plurality of large language models (LLMs), including (i) a first LLM configured to identify objectives for the wearer to accomplish, (ii) a second LLM configured to cause the AR device to obtain relevant data about the physical surroundings of the wearer, and (iii) a third LLM configured to cause the AR device to present visual representations of activities for the wearer to perform:
presenting, via the first LLM of the AI system, one or more user interface elements at the AR device related to identifying objectives of the wearer to accomplish;
in accordance with identifying, based on respective user inputs directed to the one or more user interface elements, one or more performance objectives for the wearer to accomplish, causing, via the second LLM of the AI system, one or more imaging sensors of the AR device to obtain a set of images of the physical surroundings of the wearer, wherein the set of images are directed to a physical object in the physical surroundings that is recognized by the AI system as usable for performing a respective activity for accomplishing a respective objective of the one or more performance objectives;
causing, via the second LLM, presentation of a prompt requesting additional information from the wearer related to the physical object recognized in the physical surroundings;
in accordance with determining that the AR device has caused capturing of additional data related to the physical object based on a response to the prompt, providing the additional data to the third LLM of the AI system; and
in accordance with a determination by the third LLM that visualization criteria are met based on the additional data, causing presentation, via the AR device and within the field of view of the physical surroundings, of a set of visual representations of respective activities for accomplishing at least one performance objective of the one or more performance objectives, wherein at least one visual representation of the set of visual representations depicts the recognized physical object from the physical surroundings of the wearer being used to perform the respective activity.

2. The method of claim 1, wherein the at least one visual representation includes a visualization of the wearer performing the respective activity using the recognized physical object at a location within the physical surroundings of the wearer.

3. The method of claim 1, further comprising:
detecting, via one or more audio sensors of the AR device, audio data from the physical surroundings of the wearer;
determining, based on the audio data, an audio context associated with the physical surroundings of the wearer; and
in accordance with identifying, based on the audio context and without requiring explicit initiation by the wearer, that a proactive visual action loop should be presented, causing presentation, via the AR device, of an additional set of visual representations associated with the audio context.

4. The method of claim 1, further comprising:
determining, based on sensor data associated with the wearer, that the wearer has been sedentary for a duration exceeding a threshold duration; and
in accordance with determining that the wearer has been sedentary for the duration exceeding the threshold duration, causing presentation of a visual representation prompting the wearer to perform a physical activity, wherein the visual representation is based on one or more physical objects within the physical surroundings of the wearer that are associated with performing the physical activity.

5. The method of claim 1, further comprising:
determining one or more intermediate objectives required for completing the one or more performance objectives; and
generating respective visual representations of each of the one or more intermediate objectives as part of generating the set of visual representations.

6. The method of claim 1, further comprising:
recognizing, via the one or more imaging sensors, one or more food items within the physical surroundings of the wearer; and
in accordance with recognizing the one or more food items, causing presentation of a visual representation suggesting a healthier food alternative to at least one of the one or more food items, wherein the healthier food alternative is determined based on the one or more performance objectives of the wearer.

7. The method of claim 1, further comprising:
receiving sensor data from a sensor device associated with the wearer; and
causing presentation of a visual representation depicting the wearer performing a particular activity, wherein the visual representation includes an overlay of performance metrics derived from the sensor data, and wherein the performance metrics are displayed in real-time relative to the wearer's movements during the particular activity.

8. A non-transitory, computer-readable storage medium including executable instructions that, when executed by one or more processors of an augmented-reality (AR) device, cause the AR device to perform operations comprising:
at the AR device configured to present user interface elements positioned within a field of view of physical surroundings of a wearer of the AR device, wherein the AR device is in electronic communication with an AI system that comprises a plurality of large language models (LLMs), including (i) a first LLM configured to identify objectives for the wearer to accomplish, (ii) a second LLM configured to cause the AR device to obtain relevant data about the physical surroundings of the wearer, and (iii) a third LLM configured to cause the AR device to present visual representations of activities for the wearer to perform:
presenting, via the first LLM of the AI system, one or more user interface elements at the AR device related to identifying objectives of the wearer to accomplish;
in accordance with identifying, based on respective user inputs directed to the one or more user interface elements, one or more performance objectives for the wearer to accomplish, causing, via the second LLM of the AI system, one or more imaging sensors of the AR device to obtain a set of images of the physical surroundings of the wearer, wherein the set of images are directed to a physical object in the physical surroundings that is recognized by the AI system as usable for performing a respective activity for accomplishing a respective objective of the one or more performance objectives;
causing, via the second LLM, presentation of a prompt requesting additional information from the wearer related to the physical object recognized in the physical surroundings;
in accordance with determining that the AR device has caused capturing of additional data related to the physical object based on a response to the prompt, providing the additional data to the third LLM of the AI system; and
in accordance with a determination by the third LLM that visualization criteria are met based on the additional data, causing presentation, via the AR device and within the field of view of the physical surroundings, of a set of visual representations of respective activities for accomplishing at least one performance objective of the one or more performance objectives, wherein at least one visual representation of the set of visual representations depicts the recognized physical object from the physical surroundings of the wearer being used to perform the respective activity.

9. The non-transitory, computer-readable storage medium of claim 8, wherein the at least one visual representation includes a visualization of the wearer performing the respective activity using the recognized physical object at a location within the physical surroundings of the wearer.

10. The non-transitory, computer-readable storage medium of claim 8, wherein the operations further comprise:
detecting, via one or more audio sensors of the AR device, audio data from the physical surroundings of the wearer;
determining, based on the audio data, an audio context associated with the physical surroundings of the wearer; and
in accordance with identifying, based on the audio context and without requiring explicit initiation by the wearer, that a proactive visual action loop should be presented, causing presentation, via the AR device, of an additional set of visual representations associated with the audio context.

11. The non-transitory, computer-readable storage medium of claim 8, wherein the operations further comprise:
determining, based on sensor data associated with the wearer, that the wearer has been sedentary for a duration exceeding a threshold duration; and
in accordance with determining that the wearer has been sedentary for the duration exceeding the threshold duration, causing presentation of a visual representation prompting the wearer to perform a physical activity, wherein the visual representation is based on one or more physical objects within the physical surroundings of the wearer that are associated with performing the physical activity.

12. The non-transitory, computer-readable storage medium of claim 8, wherein the operations further comprise:
determining one or more intermediate objectives required for completing the one or more performance objectives; and
generating respective visual representations of each of the one or more intermediate objectives as part of generating the set of visual representations.

13. The non-transitory, computer-readable storage medium of claim 8, wherein the operations further comprise:
recognizing, via the one or more imaging sensors, one or more food items within the physical surroundings of the wearer; and
in accordance with recognizing the one or more food items, causing presentation of a visual representation suggesting a healthier food alternative to at least one of the one or more food items, wherein the healthier food alternative is determined based on the one or more performance objectives of the wearer.

14. The non-transitory, computer-readable storage medium of claim 8, wherein the operations further comprise:
receiving sensor data from a sensor device associated with the wearer; and
causing presentation of a visual representation depicting the wearer performing a particular activity, wherein the visual representation includes an overlay of performance metrics derived from the sensor data, and wherein the performance metrics are displayed in real-time relative to the wearer's movements during the particular activity.

15. An augmented-reality (AR) device, comprising:
a display configured to present user interface elements positioned within a field of view of physical surroundings of a wearer of the AR device;
one or more imaging sensors;
one or more processors; and
memory storing instructions that, when executed by the one or more processors, cause the AR device to perform operations comprising:
at the AR device, wherein the AR device is in electronic communication with an AI system that comprises a plurality of large language models (LLMs), including (i) a first LLM configured to identify objectives for the wearer to accomplish, (ii) a second LLM configured to cause the AR device to obtain relevant data about the physical surroundings of the wearer, and (iii) a third LLM configured to cause the AR device to present visual representations of activities for the wearer to perform:
presenting, via the first LLM of the AI system, one or more user interface elements at the AR device related to identifying objectives of the wearer to accomplish;
in accordance with identifying, based on respective user inputs directed to the one or more user interface elements, one or more performance objectives for the wearer to accomplish, causing, via the second LLM of the AI system, the one or more imaging sensors to obtain a set of images of the physical surroundings of the wearer, wherein the set of images are directed to a physical object in the physical surroundings that is recognized by the AI system as usable for performing a respective activity for accomplishing a respective objective of the one or more performance objectives;
causing, via the second LLM, presentation of a prompt requesting additional information from the wearer related to the physical object recognized in the physical surroundings;
in accordance with determining that the AR device has caused capturing of additional data related to the physical object based on a response to the prompt, providing the additional data to the third LLM of the AI system; and
in accordance with a determination by the third LLM that visualization criteria are met based on the additional data, causing presentation, via the display and within the field of view of the physical surroundings, of a set of visual representations of respective activities for accomplishing at least one performance objective of the one or more performance objectives, wherein at least one visual representation of the set of visual representations depicts the recognized physical object from the physical surroundings of the wearer being used to perform the respective activity.

16. The AR device of claim 15, wherein the at least one visual representation includes a visualization of the wearer performing the respective activity using the recognized physical object at a location within the physical surroundings of the wearer.

17. The AR device of claim 15, wherein the operations further comprise:
detecting, via one or more audio sensors of the AR device, audio data from the physical surroundings of the wearer;
determining, based on the audio data, an audio context associated with the physical surroundings of the wearer; and
in accordance with identifying, based on the audio context and without requiring explicit initiation by the wearer, that a proactive visual action loop should be presented, causing presentation, via the display, of an additional set of visual representations associated with the audio context.

18. The AR device of claim 15, wherein the operations further comprise:
determining, based on sensor data associated with the wearer, that the wearer has been sedentary for a duration exceeding a threshold duration; and
in accordance with determining that the wearer has been sedentary for the duration exceeding the threshold duration, causing presentation of a visual representation prompting the wearer to perform a physical activity, wherein the visual representation is based on one or more physical objects within the physical surroundings of the wearer that are associated with performing the physical activity.

19. The AR device of claim 15, wherein the operations further comprise:
determining one or more intermediate objectives required for completing the one or more performance objectives; and
generating respective visual representations of each of the one or more intermediate objectives as part of generating the set of visual representations.

20. The AR device of claim 15, wherein the operations further comprise:
recognizing, via the one or more imaging sensors, one or more food items within the physical surroundings of the wearer; and
in accordance with recognizing the one or more food items, causing presentation of a visual representation suggesting a healthier food alternative to at least one of the one or more food items, wherein the healthier food alternative is determined based on the one or more performance objectives of the wearer.
